(19) United States
(12) Patent Application Publication
(10) Pub. No.: US 2005/0084189 A1
(43) Pub. Date: Apr. 21, 2005

(54) Hydrodynamic bearing system

(76) Inventor: Juergen Oelsch, Hohenroth (DE)

Correspondence Address: BAKER & DANIELS;111 E. WAYNE STREET, SUITE 800, FORT WAYNE, IN, 46802, US

(21) Appl. No.: 10/968,527

(22) Filed: Oct. 19, 2004

(30) Foreign Application Priority Data
Oct. 21, 2003 (DE) 203 16 131.9

(51) Int. Cl. F16C 32/06

(52) U.S. Cl. 384/107

(57) ABSTRACT

The invention relates to a hydrodynamic bearing system particularly for use as a rotary bearing in a spindle motor for a hard disk drive, comprising a shaft, a thrust plate firmly connected to the shaft by means of a pressfit connection and a bearing sleeve closed at least at one end by a cover plate, the bearing sleeve enclosing the shaft and the thrust plate with a slight radial or axial spacing forming a concentric bearing gap filled with a lubricant. In the hydrodynamic bearing system according to the invention, it is provided that the outer circumference of the shaft, in the area of connection with the thrust plate, has a surface interrupted by regular depressions, preferably formed by knurling, in order to decrease the contact surface proportion of the fit surface. As an alternative, the inner circumference of the thrust plate can also be knurled in the area of connection with the shaft.

### BACKGROUND OF THE INVENTION

The invention relates to a hydrodynamic bearing system particularly for spindle motors in hard disk drives according to the preamble of claim 1.

### Outline of the Prior Art

Hydrodynamic bearings are being increasingly employed as rotary bearings in spindle motors, as used for example to drive platters in hard disk drives, alongside roller bearings which have been used for this purpose for a long time. A hydrodynamic bearing is a further development of a sliding bearing formed from a bearing sleeve having a cylindrical inner bearing surface and a shaft having a cylindrical outer bearing surface set into the sleeve. The diameter of the shaft is slightly smaller than the inside diameter of the sleeve as a result of which a concentric bearing gap is formed between the two bearing surfaces, the bearing gap being filled with a lubricant, preferably an oil, forming a continuous capillary film.

Together, the bearing sleeve and shaft form the radial bearing region. A groove pattern is formed on at least one of the two bearing surfaces, the groove pattern exerting local accelerating forces on the lubricant located in the bearing gap due to the relative rotary movement. A kind of pumping action is created in this way which presses the lubricant through the bearing gap under pressure and results in the formation of a homogeneous lubricating film of regular thickness which is stabilized by means of hydrodynamic pressure zones. The continuous, capillary lubricating film and the self-centering mechanism of the hydrodynamic radial bearing ensure that the rotation between shaft and tube is stable and concentric.

The bearing is stabilized along the rotational axis by means of an appropriately designed hydrodynamic axial bearing or thrust bearing. The thrust bearing is preferably formed by the two end faces of a thrust plate disposed at one end of the shaft, the thrust plate being accommodated in a recess formed by the bearing sleeve and a cover plate. One end face of the thrust plate is associated with a corresponding end face of the bearing sleeve and the other end face is associated with an inner end face of the cover plate. The cover plate acts as a counter bearing to the thrust plate and seals the entire bearing system from below, preventing air from penetrating into the bearing gap filled with lubricant or from lubricant escaping from the bearing gap. In the case of a hydrodynamic axial bearing as well, the bearing surfaces that interact with each other are provided with a groove pattern in order to generate the hydrodynamic pressure required for the axial positioning of the thrust plate or the shaft in a stable manner and to ensure the circulation of the lubricant within the region of the axial bearing.

At the opposite end of the bearing, a free area can be formed acting as both a lubricant reservoir and as an expansion volume for the lubricant. This area also takes on the function of sealing the bearing. Under the influence of capillary forces, the oil located in the free area between the shaft and the tapered outlet of the bearing sleeve forms a stable, continuous liquid film which is why this kind of seal is also referred to as a capillary seal.

A suitably designed groove pattern for the radial bearing region mentioned above can cause a pumping effect to be exerted on the lubricant in the bearing gap when the shaft is rotated. Hydrodynamic pressure is built up which is greater in the radial bearing region abutting the axial bearing region than in the radial bearing region abutting the free end of the shaft. If appropriate re-circulation channels are provided, a constant flow will occur in which the lubricant within the bearing gap moves towards the closed end of the bearing. It is clear that the pressure then building up in an axial direction of the bearing also prevails in the axial bearing region and results in the thrust plate not rotating in the middle of the recess that encloses it as expected, but rather that the axial bearing gap between the end faces of the thrust plate and the bearing sleeve being significantly smaller than the bearing gap between the end faces of the thrust plate and the cover plate. The projection surfaces of the thrust plate in both axial directions are the same size so that the opposing forces acting on the thrust plate are the same in each direction and cancel each other out. This balance of forces, however, is disrupted by an additional force acting on the system which is created by the free end of the shaft also being subjected to fluid pressure in the bearing gap between the thrust plate and the cover plate. This additional force moves the shaft and the thrust plate firmly fixed to the shaft away from the cover plate in the direction of the bearing tube. The axial spacing between the end faces of the thrust plate and bearing tube then becomes smaller whereas the spacing between the end faces of the thrust plate and cover plate becomes larger. However, since the smaller the thickness of the bearing gap, the greater the hydrodynamic pressure, the hydrodynamic pressure in the bearing gap between the thrust plate and the bearing tube increases and the hydrodynamic pressure between the thrust plate and the cover plate decreases. The resulting force of these forces arising from the hydrodynamic pressure on both sides of the thrust plate is directed against the above-mentioned force and the smaller the axial bearing gap between the thrust plate and the bearing sleeve, the greater it is. The thrust plate achieves a stable axial position when both resulting forces are equal and opposite.

Depending on the design and the load on the bearing, this imbalance of hydrodynamic pressure caused by the different active surfaces in the axial bearing can result in the bearing gap between the end face of the thrust plate and the bearing sleeve becoming so small that the frictional losses increasing disproportionately to the decrease in the bearing gap can cause a rise in the local temperature of the lubricant. The load carrying capacity of the axial bearing, however, is reduced due to the thermally-induced decline in its viscosity as a result of which the already narrow bearing gap is reduced even further. The end face of the thrust plate could then come dangerously close to the bearing sleeve and perhaps even touch it, which could go to shorten the useful life of the bearing or even result in damage to the bearing. To avoid local overheating of the lubricant producing the negative effects outlined above, it is known to provide connecting bores between the bearing gaps which ensure a continuous exchange of lubricant between the individual regions of the bearing gap. For this purpose, both the bearing sleeve and the thrust plate have to be provided with through holes which involves a great deal of work. If the holes are not disposed in an exactly symmetric manner this could lead to an imbalance of the rotating parts.

The parts that are fixed to each other in such a bearing system are generally connected to each other by a pressfit connection. In assembling such a bearing, in particular, when mounting the thrust plate onto the shaft and mounting the bearing sleeve into a bearing receiving portion, “seizing” of the pressfit surfaces can occur during the joining process due to the necessarily tight fit. This can impair the concentricity and the evenness as well as the right angularity of the parts that are to be joined.

### SUMMARY OF THE INVENTION

It is thus the object of the invention to provide a hydrodynamic bearing system in which the above-mentioned problems when connecting the parts can be avoided, and a more effective circulation of lubricant can be achieved.

This object has been achieved by a hydrodynamic bearing having the characteristics outlined in claim 1.

Beneficial embodiments of the invention are outlined in the subordinate patent claims.

The invention provides a hydrodynamic bearing system, particularly for a spindle motor, comprising a shaft, a thrust plate firmly connected to the shaft and a bearing sleeve closed at one end by a cover plate, the bearing sleeve enclosing the shaft and the thrust plate with a slight spacing forming a concentric bearing gap filled with a lubricant. The shaft and thrust plate are connected to each other by means of a pressfit connection.

In the hydrodynamic bearing system according to the invention, provision is made for the proportion of contact area of the fit surfaces in the connection area between the thrust plate and the shaft to be reduced in that regularly arranged depressions, which run mainly parallel to the axis and are formed in a non-cutting or cutting process, interrupt the cylindrical joint surface on at least one of the two components. The depressions are preferably produced by means of “knurling”. A reduction of the fit surfaces of preferably 20% or more can be provided.

Here, either the outer circumference of the shaft in the area of connection with the thrust plate can be knurled or the inner circumference of the thrust plate. It is particularly advantageous if the shaft is knurled since the shaft and knurl can be formed to size together in one operation, by grinding for example. A pressfit connection with a previously knurled and ground connecting surface has the advantage over parts with smooth, non-interrupted cylindrical fit surfaces that pressfitting can be carried out using less force and there is a greatly reduced tendency for the parts to “seize” and tilt.

Knurling is carried out before final grinding or lapping of the parts that are to be connected. Knurling is a common process in metal working and can be carried out relatively simply and at low cost.

In a preferred embodiment of the invention, the knurling extends over the entire joint length between the shaft and the thrust plate. In this case, axial “channels” remain in the fit joint after the parts have been joined and are distributed evenly over its circumference, the “channels” creating a fluid-carrying connection between the bearing gaps of the axial bearing region abutting the two end faces of the thrust plate. Lubricant can move from one bearing gap to the other via these channels on the circumference of the shaft and flow back via the abaxial radial gap at the outer circumference of the thrust plate which goes to ensure a continuous circulation around the thrust plate. At the same time, this allows the thrust plate to float up more rapidly so that the critical area of mixed friction on start-up and run-down of the motor is passed through more rapidly.

This means that not only can the bearing fluid enter into and circulate in the axial bearing region from the radial bearing region via the bearing gap but also via these channels which are in direct axial extension of the radial bearing gap. The constant flow of fluid within the bearing gap goes to prevent local overheating of the bearing fluid and ensures a more even temperature distribution. This greatly lessens the probability of the bearing being damaged through stationary and rotating axial bearing components touching each other. Moreover, the bearing can be subjected to the same load in both axial directions although the stiffness characteristics can deviate from each other.

The invention can be advantageously applied in such hydrodynamic bearing systems in which the bearing sleeve is disposed within a bearing receiving portion and pressfitted with this receiving portion. Here, either the outer circumference of the bearing sleeve can be knurled in the connection area with the bearing receiving portion or the inner circumference of the bearing receiving portion is knurled in the connection area with the bearing sleeve.

In this embodiment of the invention as well, the knurl extends over the entire joint length between the bearing sleeve and the bearing receiving portion and is preferably designed in such a way that lubricant-carrying channels are formed which connect the lubricant-carrying region abutting one end of the bearing sleeve to the axial bearing region abutting the other end of the bearing sleeve.

The invention also relates to hydrodynamic bearing systems in which an equalizing volume for the bearing fluid is provided in the region of one end of the bearing, the equalizing volume preferably taking the form of a cavity having an approximately conical cross-section connected directly or indirectly to the bearing gap. In accordance with the invention, provision can be made here for the knurl in the connection area of the bearing sleeve and the bearing receiving portion to be designed in such a way that a lubricant-carrying connection between the equalizing volume and regions of the bearing gap is formed.

Provision can also be made for a lubricant-carrying connection between the equalizing volume and the bearing gap to be formed exclusively by the said channels.

Further characteristics, advantages and possible applications of the invention can be derived from the following description of the drawings.

### BRIEF DESCRIPTION OF THE DRAWINGS

The invention is described in more detail below on the basis of preferred embodiments with reference to the drawings. The figures show:

FIG. 1 a schematic longitudinal view of a hydrodynamic bearing system according to a first embodiment of the invention;

FIG. 1a the knurled shaft in half-section;

FIG. 1b the completed shaft after being pressfitted into the thrust plate in half-section;

FIG. 2 a schematic longitudinal view of a hydrodynamic bearing system according to a second embodiment of the invention;

FIG. 3 a schematic longitudinal view of a hydrodynamic bearing system according to a third embodiment of the invention.

### DESCRIPTION OF PREFERRED EMBODIMENTS OF THE INVENTION

The drawings show hydrodynamic bearing systems for spindle motors in hard disk drives according to the invention. In the illustrated embodiments, the shaft is rotatably supported in a stationary bearing sleeve. It is of course clear that the invention also includes designs in which a stationary shaft is enclosed by a rotating bearing sleeve.

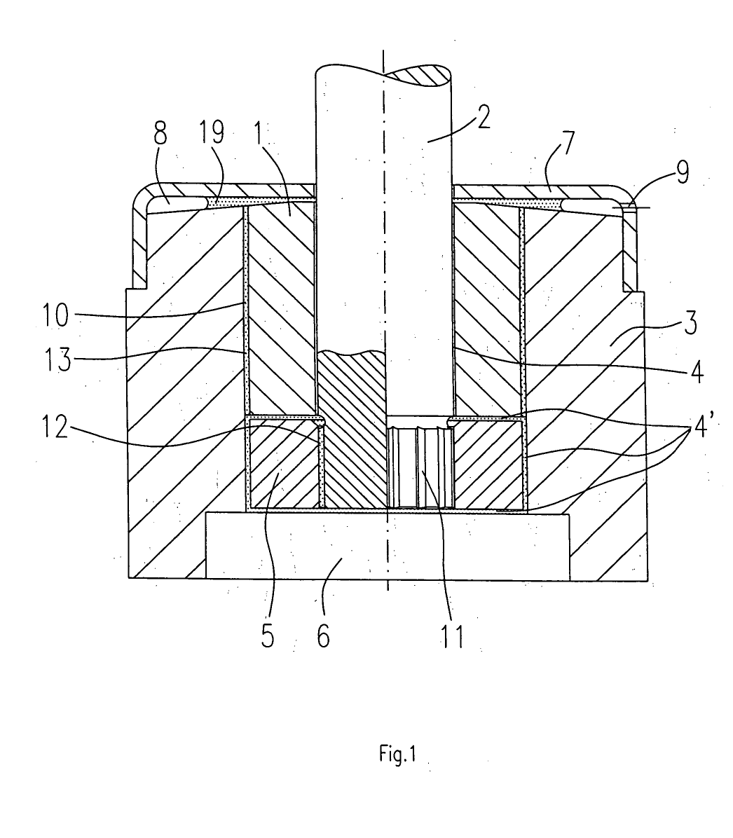

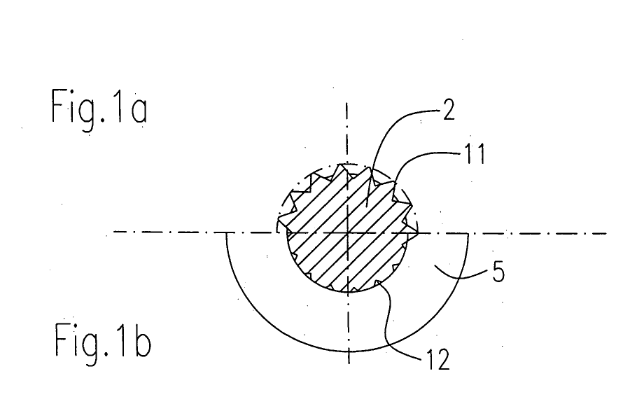

The bearing arrangement according to FIG. 1 comprises an inner bearing sleeve 1 having an axial cylindrical bore in which a shaft 2 is rotatably accommodated. The bearing sleeve 1 itself is pressed into a bearing receiving portion 3. Between the inside diameter of the bearing sleeve 1 and the slightly smaller outside diameter of the shaft 2, there is at least one radial bearing region provided with a bearing gap 4 that is filled with a lubricant, preferably a liquid bearing fluid. This radial bearing region is marked by a groove pattern (not illustrated) that is provided on the surface of the shaft 2 and/or on the inner surface of the bearing sleeve 1. As soon as the shaft 2 is set in rotation, hydrodynamic pressure is built up in the bearing gap 4 or in the lubricant found in the bearing gap due to the groove pattern, so that the bearing can then support a load.

A hydrodynamic thrust bearing formed at the lower end of the shaft 2 by a thrust plate 5 connected to the shaft 2 and a cover plate 6 provides for the axial positioning of the shaft 2 with respect to the bearing sleeve 1 of the bearing arrangement and takes up the axial load. This axial bearing region is hermetically sealed by the cover plate 6 so that no lubricant can escape from the bearing gap 4 which continues as a bearing gap 4′ between the thrust plate 5, bearing sleeve 1 and bearing receiving portion 3. To ensure that sufficient hydrodynamic pressure is built up in the axial bearing, the surfaces of the thrust plate 5 and/or the cover plate 6 facing each other are provided with a groove pattern.

The shaft 2 protrudes from the bearing sleeve 1 at its free end. The bearing receiving portion 3, together with the bearing sleeve 1, is preferably sealed at this end by a can-shaped covering cap 7 that is set on a shoulder of the bearing receiving portion 3. The covered end face of the bearing receiving portion 3 and also a part of the end face of the bearing sleeve 1 are provided with a chamfer or a counterbore that extends from the region of the bearing sleeve 1 close to the shaft radially outwards as far as the outer circumference of the bearing receiving portion 3. This goes to form a tapered area having a conical cross-section widening towards the outside between the end faces of the bearing receiving portion 3 and the bearing sleeve 1 on the one side and the inner surface of the covering cap 7 on the other side, this tapered area acting as an equalizing volume 8 for the bearing fluid and being at least partly filled with lubricant 19. The region of the equalizing volume 8 located radially towards the inside abuts the bearing gap 4. The covering cap 7 has a filling hole 9 leading to the equalizing volume 8 for the purpose of filling in the lubricant.

The thrust plate 5 is pressfitted to the shaft 2. As can be particularly seen in FIGS. 1a and 1b, in accordance with the invention, first the outer circumference of the shaft 2 is provided with a knurl 11 in the region of the joint and the knurled shaft is then formed to size preferably using centerless grinding. On the one hand, this knurling 11 makes it easier to join the parts 2, 5 and prevents the parts 2, 5 from seizing and/or tilting by reducing the proportion of contact area in the fit joint.

On the other hand, channels 12 remain between the connected parts 2, 5 which allow the additional exchange of lubricant in the bearing gap 4′ between the upper and the lower end faces of the thrust plate 5. This goes to ensure a constant circulation of lubricant 19 around the thrust plate 5.

The bearing sleeve 1 is also connected to the bearing receiving portion 3 by means of pressfitting. Here, the outer circumference of the bearing sleeve 1 is knurled and ground where necessary, which, on the one hand, makes pressfitting into the bearing receiving portion 3 easier and, on the other hand, creates channels 13 that connect the equalizing volume 8 with region 4′ of the bearing gap. These channels thus allow an exchange of lubricant 19 between the equalizing volume 8 and region 4′ of the bearing gap, so that a constant circulation of lubricant is also ensured in the region of the radial bearing.

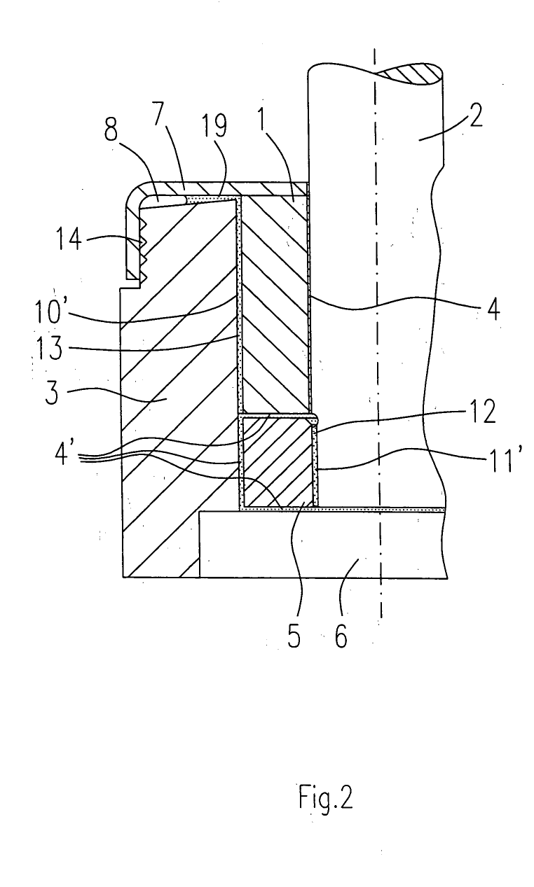

FIG. 2 shows an embodiment of the bearing system which is essentially comparable with the FIGS. 1 and 1a, 1b. Here again knurls 11′ or 10′ are provided on the outside diameter of the shaft 2 or on the outside diameter of the bearing sleeve 1 respectively.

In contrast to the FIGS. 1 and 1a, 1b the outer circumference of the bearing receiving portion 3 covered by the covering cap 7 is provided with a thread-like groove 14 that extends from the equalizing volume 8 as far as the lower edge of the covering cap 7. Via this groove 14, which establishes a connection to the outside atmosphere (pressure equalization), the equalizing volume 8 or the bearing gap 4, 4′ can be filled with lubricant 19.

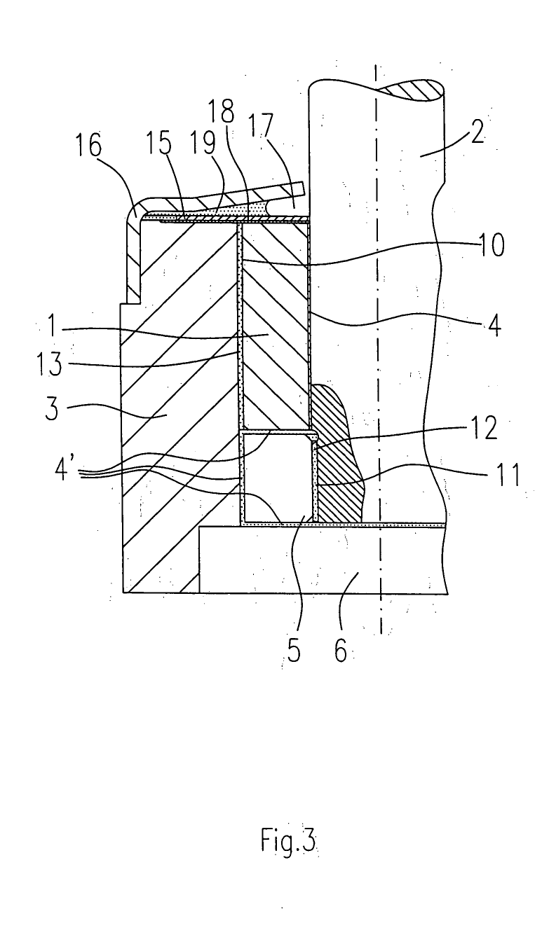

A bearing arrangement is illustrated in FIG. 3 in which a two-part bearing cover is used. The bearing cover comprises an annular disk 15 and a covering cap 16. The annular disk 15 engages against an axially arranged annular extension of the bearing receiving portion 3 and its thickness remains constant. Below the annular disk 15, that is to say, between the annular disk 15 and the bearing receiving portion 3 or bearing sleeve 1, an annular gap 18 is formed that abuts the bearing gap 4. In the same way as described above, the covering cap 16 is set on the bearing receiving portion 3. The bottom of the covering cap 16 is tapered, widening towards the shaft 2, in such a way that between the covering cap 16 and the annular disk 15, an annular cavity having a conical cross-section is formed which widens radially towards the inside and acts as an equalizing volume 17 for the bearing fluid 19. The region of the equalizing volume 17 located radially towards the outside is connected to the annular gap 18.

Via the channels 13 formed by the knurled surfaces of the bearing sleeve 1 or the bearing receiving portion 3 and the inner region of the annular gap 18, a lubricant exchange between the radial bearing gap 4 and the lower regions of the bearing gap 4′ can take place. At the same time, the bearing gap 4′ is connected to the equalizing volume 17 via the channels 13 and the outer part of the annular gap 18.

The characteristics revealed in the above description, the claims and the drawings can be important for the realization of the invention in its various embodiments both individually and in any combination whatsoever.

### Identification Reference List

1 bearing sleeve
2 shaft
3 bearing receiving portion
4 bearing gap 4′
5 thrust plate
6 cover plate
7 covering cap
8 equalizing volume
9 filling hole
10 depressions 10′ (through knurling)
11 depressions 11′ (through knurling)
12 channels
13 channels
14 groove
15 annular disk
16 covering cap
17 equalizing volume
18 annular gap
19 bearing fluid

1. Hydrodynamic bearing system comprising a shaft, a thrust plate connected to the shaft and a bearing sleeve closed at one end by a cover plate, the bearing sleeve enclosing the shaft and the thrust plate with a slight spacing forming a concentric bearing gap filled with a lubricants,
characterized in that
the proportion of contact area of the fit surfaces in the area of connection between the thrust plate and the shaft is reduced on at least one of these two components by more than three depressions formed on the circumference of the joint surface.

2. A hydrodynamic bearing system according to claim 1, characterized in that the proportion of contact area of the fit surfaces is reduced to at least 85%.

3. A hydrodynamic bearing system according to claim 1, characterized in that the depressions are created in a cutting process by material being removed.

4. A hydrodynamic bearing system according to claim 1, characterized in that the depressions are created in a non-cutting process by material being displaced.

5. A hydrodynamic bearing system according to claim 1, characterized in that the depressions at the outer circumference of the shaft in the area of connection with the thrust plate are created by knurling.

6. A hydrodynamic bearing system according to claim 1, characterized in that the depressions the inner circumference of the thrust plate in the area of connection with the shaft are created by knurling.

7. A hydrodynamic bearing system according to claim 1, characterized in that the depressions extend over the entire joint length between the shaft and the thrust plate.

8. A hydrodynamic bearing system according to claim 1, characterized in that the depressions are designed in such a way that lubricant carrying channels are formed between the regions of the bearing gap abutting the end faces of the thrust plate.

9. A hydrodynamic bearing system according to claim 1, characterized in that the bearing sleeve is disposed within a bearing receiving portion and is pressfitted to it.

10. A hydrodynamic bearing system according to claim 9, characterized in that the outer circumference of the bearing sleeve or the inner circumference of the bearing receiving portion in the fit joint of the common area of connection is provided with regular depressions arranged on the circumference and preferably running parallel to the axis.

11. A hydrodynamic bearing system according to claim 10, characterized in that the depressions are created in a cutting process by material being removed.

12. A hydrodynamic bearing system according to claim 10, characterized in that the depressions are created in a non-cutting process by material being displaced.

13. A hydrodynamic bearing system according to claim 10, characterized in that the depressions are created by knurling.

14. A hydrodynamic bearing system according to claim 10, characterized in that the depressions extend over the entire joint length between the bearing sleeve and the bearing receiving portion.

15. A hydrodynamic bearing system according to claim 10, characterized in that the depressions are designed in such a way that lubricant carrying channels are formed between the end faces of the bearing sleeve, the channels creating a connection to the bearing gap.

16. A hydrodynamic bearing system according to claim 10, characterized in that an equalizing volume for the lubricant is provided in the region of at least one end of the bearing system.

17. A hydrodynamic bearing system according to claim 10, characterized in that the equalizing volume takes the form of a cavity having an approximately conical cross-section connected directly or indirectly to the bearing gap.

18. A hydrodynamic bearing system according to claim 10, characterized in that the depressions are designed in such a way that lubricant-carrying channels are formed between the equalizing volume and regions of the bearing gap.

19. A hydrodynamic bearing system according to claim 2, characterized in that the depressions are created in a cutting process by material being removed.

20. A hydrodynamic bearing system according to claim 2 characterized in that the depressions are created in a non-cutting process by material being displaced.
